(19) United States
(12) Patent Application Publication
(10) Pub. No.: US 2007/0095294 A1
(43) Pub. Date: May 3, 2007

(54) Treat composition for use with a pet treat launching device

(76) Inventor: Reynolds Ellswoth Moulton, Brooklyn, NY (US)

Correspondence Address: DOGMATIC PRODUCTS, INC., 158 SUMMIT STREET, BROOKLYN, NY, 11231, US

(21) Appl. No.: 11/365,447

(22) Filed: Mar. 1, 2006

Related U.S. Application Data
(63) Continuation-in-part of application No. 11/264,225, filed on Oct. 31, 2005.

(51) Int. Cl. A01K 5/00

(52) U.S. Cl. 119/51.01

(57) ABSTRACT

In one embodiment, a pet treat, comprises a fiber material in an amount effective to provide predetermined rigidity to treat, such that for dispensing, the treat is capable of being freely ejected to a location at a distance from a launching-type dispensing device, and capable of being substantially effortlessly palatable by pet.

### PARENT CASE

This patent application is a continuation-in-part of Ser. No. 11/264,225 and filed 31 Oct. 2005 by Reynolds E. Moulton III and entitled “A treat dispensing device and a method thereof”.

### FIELD OF THE INVENTION

This invention relates generally to treat compositions and more particularly to a treat composition for use especially with a launching type treat dispensing device for pets such as, for example, cats, dogs, etc.

### BACKGROUND OF THE INVENTION

Various compositions of treats are available in the market for use with treat dispensing devices. However there exists no suitable treat composition for use with launching type treat dispensing device that uses substantial pressure for launching the treat and hence interactive treat dispensing. Interactive treat dispensing is more often recommended for having combined fin and exercise for improved health of pets.

Currently pet obesity in the United States is 44% for dogs and 25-50% for cats. Thus there exists a need for a treat composition that would withstand substantial pressure during launching and sustain its shape for efficient launching and interactive treat dispensing to pets.

### SUMMARY OF THE INVENTION

The above-mentioned shortcomings, disadvantages and problems are addressed herein, which will be understood by reading and studying the following specification.

In one embodiment, a pet treat, comprises a fiber material in an amount effective to provide predetermined rigidity to treat, such that for dispensing, the treat is capable of being freely ejected to a location at a distance from a launching-type dispensing device, and capable of being substantially effortlessly palatable by pet.

In an embodiment, a pet treat composition is provided. Accordingly, the pet treat composition comprises crude protein of at least 50 wt %; crude fat of at least 4 wt %; crude fiber of at least 3 wt %; and moisture content of up to 12 wt %, wherein the composition is capable of being shaped into a rigid treat, wherein the treat is adapted for withstanding substantial pressure applied during launching by a dispenser.

In yet another embodiment, a treat dispensing method for pets comprises loading one or more treats into a launching-type dispensing device, and ejecting the loaded treats from the launching-type dispensing device, wherein the treats are composed of cellulose content material in an amount effective to provide predetermined rigidity to the treats so as to be freely ejectable from the dispensing device and palatable by pets.

### DETAILED DESCRIPTION OF THE INVENTION

In the following detailed description, various embodiments are described in sufficient detail to enable those skilled in the art to practice the embodiments, and it is to be understood that logical changes may be made without departing from the scope of the embodiments. The following detailed description is, therefore, not to be taken in a limiting sense.

Various embodiments of this invention provide a treat composition for use with a pet treat launching device.

In one embodiment, the pet treat according to this invention comprises a fiber material in an amount effective to provide predetermined rigidity to treat, such that for dispensing, the treat is capable of being freely ejected to a location at a distance from a launching-type dispensing device, and capable of being substantially effortlessly palatable by pet.

In this embodiment, the fiber material includes cellulose fiber and the launching-type dispensing device includes a hand-held treat launching gun (not illustrated).

In some embodiment, the treats have at least one of a ball shape or a disc shape. It should be noted that having ball or a disc shape for the treat reduces drag and hence provides tension free ejection from the launching device.

In another embodiment, a pet treat composition according to this invention comprises crude protein of at least 50 wt %, crude fat of at least 4 wt %, crude fiber of at least 3 wt % and moisture content of up to 12 wt %, wherein the composition is capable of being shaped into a rigid treat wherein the treat is adapted for withstanding substantial pressure applied during launching by a dispenser.

In one example, ingredients that form protein content comprise of at least one of processed wheat gluten and a hydrolysed protein. In a further example, wheat gluten is concentrated using hot water to extract starch out of wheat. The left over material comprises protein.

In one example, ingredients that form fat comprises comprise of at least one of glycerin and monoglycerides of an edible fatty acid. In a further example, a 3-carbon molecule that occurs naturally in fats and glycerin is split from the three fatty acids of fats and oils. This serves to allow processed wheat gluten to be molded into a physical form such as into a ball shape or a disc shape.

In one example, ingredients that form the fiber content comprise of at least cellulose. In another example, the cellulose may be made from a powdered plant material. In further example, the cellulose may have high purity and non-antigenic properties.

In an embodiment, the pet treat composition according to this invention comprises a further ingredient comprising a natural flavor. The natural flavor may be in substantially small quantity. In further example, the natural flavor may be free from any beef protein.

In another embodiment, the pet treat composition according to this invention comprises a further ingredient comprising a lubricant material for molding into a rigid treat. For example, the lubricant material may include magnesium stearate.

In a further embodiment, the pet treat composition according to this invention comprises a nutritional mineral. For example, the nutritional mineral is monosodium phosphate.

In further embodiments, the pet treat composition according to this invention comprises a color pigment such as, for example, chlorophyll. In yet further embodiments, the pet treat composition according to this invention may comprise a preservative such as for example potassium sorbate.

In some embodiment, a treat dispensing method for pets according to this invention comprises loading one or more treats into a launching-type dispensing device, and ejecting the loaded treats from the launching-type dispensing device, wherein the treats are composed of cellulose content material in an amount effective to provide predetermined rigidity to the treats so as to be freely ejectable from the dispensing device and palatable by pets.

It should be noted that the pet treat composition according to this invention gives sufficient rigidity to be ejected from a launching-type treat dispensing device to a location at a distance. Moreover, the composition provides for sufficient rigidity for the treats to be easily palatable by pets.

It should also be noted that the treat composition according to this invention does not fragment when pressure/force is applied during launching and also remain sufficiently soft to be palatable by pet. This creates an interactive activity for pet owner and pet such as, for example, dog, cat.

It should also be noted that the interactive treat dispensing provides a treating experience that increases potential exercise in pets. Furthermore, the interactive treat dispensing method with the treat composition according to this invention and the launching-type treat dispensing device creates a fun way of turning treating into a game.

Thus, various embodiments of the present invention provide a treat composition for pets and a method of dispensing treats to pets. It will be obvious for a person of skilled in the art to practice the invention with modifications. However, all those modifications will be deemed to be covered within the scope of the invention as covered in the claims.

What is claimed is:

1. A pet treat, comprising a fiber material in an amount effective to provide predetermined rigidity to treat, such that for dispensing, the treat is:
(i) capable of being freely ejected to a location at a distance from a launching-type dispensing device, and
(ii) capable of being substantially effortlessly palatable by pet.

2. A pet treat according to claim 1 wherein the fiber material comprises cellulose.

3. A pet treat according to claim 1 wherein the launching-type dispensing device is a hand-held dispensing gun.

4. A pet treat according to claim 1 further comprising at least one of a substantially disc or ball shape.

5. A pet treat composition comprising:
(i) crude protein of at least 50 wt %;
(ii) crude fat of at least 4 wt %;
(iii) crude fiber of at least 3 wt %; and
(iv) moisture content of up to 12 wt %, wherein the composition is capable of being shaped into a rigid treat wherein the treat is adapted for withstanding substantial pressure applied during launching by a dispenser.

6. A pet treat composition according to claim 5 wherein the protein comprises at least one of processed wheat gluten and a hydrolysed protein.

7. A pet treat composition according to claim 5 wherein fat comprises at least one of glycerin and monoglycerides of an edible fatty acid.

8. A pet treat composition according to claim 5 wherein the fiber comprises cellulose.

9. A pet treat composition according to claim 5 further comprising a natural flavor.

10. A pet treat composition according to claim 5 further comprising a lubricant material for shaping into a rigid treat.

11. A pet treat composition according to claim 10 wherein the lubricant material is magnesium stearate.

12. A pet treat composition according to claim 5 further comprising a nutritional mineral.

13. A pet treat composition according to claim 12 wherein the nutritional mineral is monosodium phosphate.

14. A pet treat composition according to claim 5 further comprising a color pigment.

15. A pet treat composition according to claim 14 wherein the color pigment is chlorophyll.

16. A pet treat composition according to claim 5 further comprising a preservative.

17. A pet treat composition according to claim 16 wherein the preservative is potassium sorbate.

18. A pet treat composition according to claim 5 wherein the shape includes at least one of a ball and a disc.

19. A pet treat composition according to claim 5 wherein the launching device comprises a hand-held dispensing gun.

20. A treat dispensing method for pets comprising:
(i) loading one or more treats into a launching-type dispensing device; and
(ii) ejecting the loaded treats from the launching-type dispensing device, wherein the treats are composed of cellulose content material in an amount effective to provide predetermined rigidity to the treats so as to be freely ejectable from the dispensing device and palatable by pets.
